(19) United States
(12) Patent Application Publication
(10) Pub. No.: US 2025/0239154 A1
(43) Pub. Date: Jul. 24, 2025

(54) Warning System For Warning A Vehicle Driver And Method For Warning A Vehicle Driver

(71) Applicant: MEKRA Lang GmbH & Co. KG, Ergersheim (DE)

(72) Inventor: Andreas ENZ, Burgbernheim (DE)

(73) Assignee: MEKRA Lang GmbH & Co. KG, Ergersheim (DE)

(21) Appl. No.: 18/986,130

(22) Filed: Dec. 18, 2024

(30) Foreign Application Priority Data
Dec. 27, 2023 (DE) 102023136726.9

(51) Int. Cl. G08G 1/0967; B60R 1/26; G06V 20/58; G08G 1/16; H04N 7/18

(52) U.S. Cl. CPC G08G 1/096766; B60R 1/26; G06V 20/58; H04N 7/183; B60R 2300/30; B60R 2300/8046; G06V 2201/08; G08G 1/166

(57) ABSTRACT

A warning system (100) for warning a vehicle driver; the system having a sensor (3a, 3b) for capturing ambient information; a processing unit (4) for processing information captured by the sensor; and a output unit (5, 7, 8, 9) for outputting a warning signal to the vehicle driver (1); wherein the sensor (3a, 3b) is adapted to detect information about other road users; the processing unit (4) is adapted to analyze the information with respect to the presence of one or more certain characteristics of the other road users, and to output a signal to the output unit (5) for outputting the warning signal when the analysis detects the presence of certain characteristics of other road users.

### BACKGROUND OF THE INVENTION

### 1. Field of the Invention

The invention relates to a warning system for warning a vehicle driver and a method for warning a vehicle driver, in particular when other road users/road participants who are to be given priority, because they have special rights in certain traffic situations, are in the vicinity of the vehicle.

### 2. Description of the Related Art

For vehicles the vehicle environment is usually visually monitored by providing mirrors for the driver, or increasingly providing camera monitor systems as mirror replacement systems or as a supplement to mirrors, with which the driver can see the vehicle environment in areas that are not directly visible for him during a normal driving.

Emergency vehicles, such as police vehicles or rescue vehicles, have devices for emitting light signals (in Germany, for example, usually flashing blue lights), which are switched on and used when the emergency vehicle is in use and must therefore be given priority in road traffic, i.e. the vehicle has special rights in a particular traffic situation. The light is of such a frequency and sequence of flashes that it is visible and recognizable from afar. Furthermore, the emergency vehicles are usually also equipped with sirens/horns (e.g. the so-called Martinshorn in Germany), which emit sound signals, at least in particularly traffic-critical situations, so that drivers in the vicinity of the emergency vehicles can reliably hear them and give them priority. In addition to the visual warning, an acoustic warning is also given. By such devices on emergency vehicles it can be ensured that the emergency vehicles are given priority and can therefore carry out their duty quickly without affecting traffic safety in general. To ensure that a vehicle driver can at least assign sounds, sound sequences, lights, light sequences and the like as clearly as possible to such emergency vehicles, the use of corresponding lights or sounds is often prohibited by road traffic regulations, at least for other road users, e.g. in Germany the use of blue, yellow or red flashing lights on a road user is reserved for emergency vehicles.

For the vehicle driver to recognize another road user with special rights at an early stage, it is essential that the vehicle driver always reliably observes the surroundings of his vehicle, e.g. by using the rear-view mirrors or corresponding camera monitor systems, so that vehicles approaching from behind can be recognized at an early stage, for example. Only thereby it is possible to ensure that the driver reliably takes useful and/or required measures adapted to the traffic situation in order to give priority to emergency vehicles, such as forming a rescue lane or stopping at the roadside.

In camera monitor systems, it is known to provide the vehicle driver with additional information via the monitor. Such additional information can be vehicle-related additional information, as described, for example, in DE 10 2023 106 451, which has not yet been published, or it can be additional information relating to the surroundings, as described, for example, in DE 10 2015 002 923.

The term road user refers to all vehicles and people participating in road traffic, e.g. emergency vehicles, vans, cars, trucks, bicycles, scooters, pedestrians, etc. are road users. A driver is understood as a natural person who drives a vehicle. A driver is therefore not understood as a road user per se; rather, his vehicle (with him as the driver) is the road user.

### OBJECT OF THE INVENTION

It is often difficult for the vehicle driver to acquire information in good time that indicates that an emergency vehicle is in the vicinity of his vehicle, especially if the driver is very focused on the current traffic situation, for example.

Therefore, there is a need to additionally warn a vehicle driver when an emergency vehicle is in the vicinity of his vehicle and to provide a corresponding warning system and warning method.

### SUMMARY OF THE INVENTION

The invention is based on the idea of not only capturing environmental/ambient information and possibly categorizing it into certain categories, such as other road users, obstacles, etc., but rather analyzing the captured ambient information according to further criteria for certain categories of road users and then, depending on the result of the analysis, taking or initiating measures. A system according to the invention per se does not necessarily have to assign road users to certain groups or categories, which is possible, for example, by means of image recognition and artificial intelligence. If certain criteria can be defined in advance that allow clear conclusions or substantially clear conclusions to be drawn that certain road users are involved and that certain situations having these special characteristics are present, the categorization can be carried out implicitly by specifically detecting these special characteristics, which then allows both the conclusion that it concerns a certain group of road users and the conclusion that the road user has certain characteristics. Examples of such unambiguous criteria can be the presence of signals emitted by halogen lights that are in a blue housing and have a clear IR component. Another example is LED blue light and xenon light sources (“xenon flashers”), which emit very short light pulses. These examples allow the conclusion that it is an emergency vehicle that is in action and has its signal light switched on. In particular, such an analysis can take place in such a way that the analysis is carried out with regard to a characteristic or a combination of characteristics that clearly indicate a road user with a certain characteristic, e.g. emergency vehicle with signal light switched on.

Subsequently, if the presence of such a characteristic is detected, a warning can be specifically issued to the driver and/or a corresponding signal can be output to a driver assistance system.

One possibility is to first detect and analyze whether there are any other road users in the vehicle environment at all and, if another road user is detected, to analyze whether this ambient information, in particular the other road user, has one or more specific characteristics. By the warning system carrying out a check for the presence of another road user and analyzing characteristics thereof in more detail, erroneous warnings can be minimized that are triggered, for example, by corresponding light sources or sound sources away from road traffic.

In particular, a warning system for warning a vehicle driver comprises a sensor that captures ambient information. Such a sensor can be of any suitable type of sensor, e.g. a camera to capture visual signals, a microphone to receive audio signals, a radio receiver to capture radio signals, or the like. In principle, any number of sensors of the same or different construction and/or type can be provided, which can capture ambient information in a mutually complementary or redundant manner. The information captured by the sensor is supplied to a processing unit, i.e. a processing unit is provided which processes and analyzes the information captured by the sensor. Furthermore, the warning system contains an output unit that is adapted to output a warning signal to the vehicle driver. It is also possible for the processing unit to output the signal additionally or alternatively to a driver assistance system of a vehicle, which in turn takes suitable measures and thus, for example, indirectly warns the driver or affects the vehicle. In addition, the driver assistance system could also issue a direct warning. The driver assistance system can also serve as a processing unit, i.e. a driver assistance system forms a processing unit. Preferably, the signal is transmitted to at least one output unit. The output unit can be of different types, e.g. a loudspeaker for outputting a sound signal, a display for displaying visual warning information or similar. Output units available in the vehicle, such as monitors of a mirror supplement camera monitor system, can be used. Furthermore, combinations of different types of output units can be used, which are either provided specifically for the warning system or, preferably, are components of a mirror replacement system, a vehicle assistance system or a vehicle entertainment system.

The sensor is adapted to record information about other road users. This means that the sensor is suitable for capturing ambient information that contains information about other road users. Environmental or ambient information is any kind of information that a human organ and/or a device can perceive or obtain from the environment/ambience. The warning system converts the ambient information into processable data and feeds the information recorded by the sensor to the processing unit, which analyzes and categorizes the information, or the data obtained from it with regard to whether the ambient information comprises information about specific or certain characteristics of other road users. If, for example, information is available that another road user is present in the vehicle environment, the processing unit further analyzes this information regarding whether one or more certain characteristics of the other road user are present. Another example is that the ambient information is analyzed exclusively to determine whether a certain characteristic is present that can only be assigned to a specific other road user. In this case, the analysis can be successful even if the vehicle itself is not seen by the sensor.

In particular, such characteristics or properties for which the ambient information is analyzed can be aimed at the detection of special signals, i.e. signals that serve to warn other road users by emergency vehicles by means of light signals and sound signals in order to warn of dangers and/or to indicate the use of special rights and rights of way to the remaining traffic. Such special signals are for example—depending on the country-blue, red and/or yellow flashing lights and sirens (such as Yelp- or Wail-signals) and/or subsequent horns (“Martinshorn”). Accordingly, the characteristics to be determined can be, for example, light waves of a certain wavelength (corresponding to the spectral color of light, i.e. the color recognized by human color perception), IR or UV components of light, in image analysis, for example, RGB values of a captured image, temporally determined sequences of light waves of different wavelengths, in image analysis, temporal sequences of RGB values of light and their intensity, certain tones (sound frequencies), temporally predetermined sequences of sound frequencies, Doppler effects or shifts or a special radio signal. If sound frequency shifts caused by Doppler effects are detected and determined, these can also be used for conclusions about the relative movement of the sound source with respect to the vehicle. This can also be used, for example, to determine whether the sound source itself is moving or not. Something similar can also be done by analyzing the volume of sound signals.

If the analysis of the processing unit shows that one or more certain characteristics of the other road users or of another road user are present in the vehicle environment observed by means of the sensor, the processing unit outputs a signal to the output unit so that the latter can output the warning signal, e.g. in the form of a warning tone, the reduction of the volume of an entertainment system (radio), a possibly flashing frame around an output unit, a highlighting of the road user, e.g. in the form of a graphic overlay, on a output unit or the like. Alternatively, and/or additionally, the processing unit can also transmit the signal to a driver assistance system of the vehicle so that it can take appropriate measures, such as driving slowly, stopping, etc.

By this additional warning to the driver, which takes place in addition to the direct perception of signals from emergency vehicles, for example, i.e. in addition to the driver seeing the flashing blue light or hearing a siren, for example, the driver can be warned early and reliably if an emergency vehicle is in the vicinity of his vehicle. This allows the driver and/or a driver assistance system to take appropriate measures to ensure that the emergency vehicle moves forward smoothly. This also increases road safety, as the driver can take such measures at an early stage and in a considered manner.

If the sensor is an optical sensor, the analysis of whether a road user with certain characteristics is present in the vehicle environment is preferably based on a combination of different image parameters, preferably without object recognition on the image. For example, a blue light can be detected as a temporal change in the brightness of the color values of the image, in particular the brightness of individual RGB pixels before the conversion to a color value of the image or after the conversion can be used, whereby the brightness value after the conversion represents a kind of average value. To identify a blue light, for example, the temporal brightness curve is used as a relevant feature by observing the brightness curve/profile over several frames (individual images) to determine a frequency of the brightness change. If this matches a (known) frequency of a normal (conventional) blue light, the presence of a certain characteristic of another road user is detected according to the example. In addition, a blue light may be recognized as a blue light “with the correct (actual) blue” via a color angle range, for example. This is particularly relevant if the light falls directly into the camera. If only the light reflected by an object (e.g. a house wall) falls into the camera, a color perception that may differ greatly from the actual color of the signal light must be considered (especially if it is not a reflective surface such as the windows of other vehicles, as this will then depend on the color of the object). In this case, the analysis can be based largely on the detected change in brightness. Additionally or alternatively, the number of pixels in which the periodic change in brightness is perceived can be included in the analysis. This is based on the well-known, very large beam angle of blue lights or their design/construction, which makes them visible in a large spatial area. Therefore, in relation to the image respectively the image sensors, blue lights are more likely to be visible and recognizable in a larger pixel area that extends over large area of the sensor and are less likely to be found in individual pixels, different from, for example, light indicators on the side of the road.

Preferably, the warning system is coupled to a mirror replacement system of a vehicle and the output unit of the warning system is or comprises the display which is used to show the mirror replacement information to the vehicle driver. The mirror replacement system can be any camera monitor system that can replace a mirror on the vehicle, i.e. that provides a device for indirect vision for a vehicle driver that allows the driver to see into areas of the vehicle's surroundings that would otherwise be impossible or difficult to see. The warning information is then shown visually to the driver on this display. This means that no additional components are required, and the driver is used to receiving information about the surroundings via such a display, so that he will notice it early on.

Particularly preferably, the warning signal comprises a graphic representation on the display, e.g. in the form of an overlay, which can be, for example, a highlighting of the other road user, a frame around it or the like. This also provides the driver with information on the location of the observed road user in relation to his vehicle. It is particularly preferable if the image of a mirror replacement system, e.g. a legal field of view according to UN/ECE-R46, for example the field of view of groups II and IV, is shown on the display, and the warning information, together with the location information about the other road user, is shown in an area of the display in which a legal field of view is available.

In a preferred embodiment, the warning signal is output as long as the presence of the certain characteristic or characteristics of other road users is detected or until the driver switches off the warning signal. This ensures that the driver does not miss the warning signal, e.g. because he is focused on the traffic at the start of the warning signal and is therefore not looking at the display, for example. Alternatively, the driver's perception of the warning signal can also be determined, for example, by a driver monitoring system determining that the driver has perceived the warning signal. If this is the case, the warning signal can then be switched off by the driver monitoring system.

Alternatively, the warning signal can be output for a specific, predetermined period of time (time duration).

Preferably, the warning signal is only output after a period of time (time duration) has elapsed during which the presence of the certain characteristic/property or characteristics/properties is continuously detected. This means that the sensor repeatedly and continuously captures the ambient information, and the processing unit analyzes it. A warning signal is only output when the presence of a certain characteristic of another road user is continuously detected for a certain period of time, e.g. 1 to 3 seconds. This can prevent an unnecessary warning signal caused by an emergency vehicle crossing behind the vehicle, for example. On the other hand, an emergency vehicle approaching the vehicle from behind, for example, ensures that a warning signal is output, as in this case the certain characteristic is continuously present for a certain period of time. Continuous does not necessarily mean completely uninterrupted, so that, for example, certain patterns of frequencies or wavelengths, i.e. recurrent occurrence in short periods of the observed characteristic, also fall under the term “continuous”.

The time from which the warning signal is output may depend in particular on the technical specification of one or more sensors that are used to continuously capture the ambient information. When using a camera that comprises an optical sensor, for example, as a device that captures ambient information, the time may depend, for example, on the refresh rate (frame rate) of the camera. If several sensors/cameras with different technical specifications are used, the time essentially depends, for example, on the sensor or camera with the slowest sampling rate/frame rate. However, time duration is also influenced by other components that are involved in processing the captured ambient information. For example, the time may depend on how quickly the processing unit can analyze the information. Various signal propagation times and possible latencies in the overall system can influence the time duration.

A sensor for capturing ambient information can be provided separately or be part of the mirror replacement system or camera monitor system mentioned above. In the case of a camera, for example, the warning signal can be output after a period of at least two frames up to a few image repetitions (frames), for example 3 to 5 frames, for example. Depending on the camera used, this can then correspond to a duration of 30 ms to 175 ms (for systems with typically 30-60 fps) from when the warning signal is output. Thus, incorrect warnings output to the driver can be avoided.

According to the invention, the time period (time duration) until the warning signal is actually output can also depend, for example, on a combination of a few seconds and a few frame rates. This can be the case, for example, if several different sensors are used, for example optical sensors and acoustic sensors. Optical sensors and acoustic sensors can detect a feature with a different “confidence level”, i.e. with different levels of certainty. The feature does not have to be detected by all sensors. Rather, it is sufficient if it has already been detected with sufficient certainty by one or more sensors. If, for example, an optical sensor has a confidence level of 90%, i.e. the feature is detected with 90% certainty, then the warning signal can be output without having to wait for confirmation from an acoustic sensor. If the confidence level is low, for example below 90%, it may be necessary to wait for the result of the acoustic sensor before the warning signal is output.

Additionally or alternatively, the time until the warning signal is output can depend on the detected characteristic. A frequency sequence (e.g. the typical characteristic of a siren) may have to be determined for a longer time to avoid an incorrect warning than a continuous characteristic that only needs to be detected once to determine whether it is still present in the next frame, in the case of a camera as a sensor. For frequency sequences, the time duration must therefore be at least two period lengths of the frequency sequence, preferably four to five or even more period lengths in order to ensure error-free output of the warning signal. The time duration must also be seen in the context of the available sampling rate, which is at least the frame rate (fps) or the possible exposure time (recording time) of the camera image sensor used. In particular, the duration of an acoustic frequency sequence (if the frequency sequence is assumed to be a typical characteristic of a siren) must generally be significantly longer than for optical signals, so that the duration until the warning signal is output generally depends on the type of signal.

Finally, the duration of the output of a warning signal and/or the start of the output and/or the end thereof can be dependent on other information that is acquired by the vehicle, e.g. depending on the detection of the existence of a certain traffic situation and/or ambient situation. Such traffic and/or ambient information can be determined, for example, by evaluating or analyzing the current characteristics of the vehicle (information via CAN bus, for example). For example, depending on the traffic situation, it may make sense to issue the warning for as long as the characteristic is detected, to issue the warning for a longer period or to issue a warning for a shorter period, i.e. not for the entire duration of the detection of the certain characteristic. For example, a longer warning is useful if the traffic situation or ambient information suggests that the certain characteristic can only be recognized intermittently, e.g. because the vehicle is driving on a winding road with opaque boundaries (e.g. trees, mountainside) and therefore, for example, a blue light can only be seen for a short time and is then obscured again, possibly several times. The driver can be made permanently aware that a road user who is to be given priority is approaching with a warning that lasts longer than the signal is detected. On the other hand, in traffic jam situations on the highway (vehicle is stationary or moving very slowly and is on the highway), for example, in which the vehicle driver is already expecting possible blue lights and is therefore already paying increased attention, the vehicle driver can be given a temporary, rather short warning so that the vehicle driver is not put under additional increased stress, which a permanent warning could possibly cause, during any necessary subsequent maneuvering actions in which he has to evade an emergency vehicle.

The warning signal is preferably an acoustic signal and/or a visual signal. This means that the driver can be reliably warned by means of devices that are usually already present in the vehicle, i.e. no additional equipment is required.

Examples of visual graphic warning signals can be illuminating or flashing signal lights that are specially provided, illuminating or flashing graphic symbols on a display already present in the vehicle, e.g. a head-up display, or similar. Illuminating or flashing frames around an entire display or highlighting of individual road users on a display of a camera monitor system of a mirror replacement system are further examples of visual warning signals.

Acoustic warning signals can be, for example, warning tones output from a vehicle loudspeaker, reduction of the volume of an entertainment system or the like.

Further warning signals, such as haptic signals like a vibration of the steering wheel, are also conceivable.

Preferably, the sensor comprises a camera and/or a microphone and/or a radio receiver. The sensor, especially if a camera is used, can be part of a mirror replacement system. If the sensor is a camera, the processing unit can, for example, analyze the image with respect to road users/traffic participants and certain characteristics of these. For example, the processing unit can analyze the image with respect to the presence of certain colors or the presence of certain temporal color sequences, intensities and/or brightnesses within the image. In particular, the temporal sequence of intensity and/or brightness in signals or their spatial distribution can be analyzed.

A radio receiver is particularly reliable and a simple means if the emergency vehicles or those road users from whom the presence of certain characteristic is observed are equipped with a transmitter that emits a specific radio signal as a certain characteristic. The use of a radio signal has the advantage over a visual signal, which the sensor detects, that, as with a sound signal, there does not have to be a direct view of the other road users, respectively, the characteristic must be recognizable from an image for detecting a signal.

In a particularly preferred embodiment, at least two independent, different sensors are provided. Independent, different sensors are those that are not formed by the same device, e.g. one and the same camera, and that can be operated independently of each other. The multiple sensors can be of the same or different types, i.e. two cameras can be provided as two sensors, for example. If the sensors are of the same type, i.e. e.g. several cameras or e.g. several microphones, the sensors can be provided as redundant sensors to verify the detection result of one of the sensors, or complementary sensors, for example for different areas of the vehicle environment. Furthermore, the probability of failure can be reduced by using several independent, redundant sensors. If the sensors are of the same type, for example several cameras, they can still be different cameras or sensors in terms of construction, e.g. several cameras having different resolutions.

Advantageously, the sensors are of different types, i.e. the sensor is a first sensor, and the warning system includes a second sensor which is a sensor different from and independent of the first sensor. Different sensors refer to sensors of different types, particularly regarding the type of information detected, e.g. visual information on the one hand and acoustic information on the other. Both sensors transmit the detected information to the processing unit. For example, the first sensor is a camera, and the second sensor is a radio receiver or a microphone. If the presence of another road user with a certain characteristic is detected by the processing unit using the first sensor, this can be verified independently by analyzing the information from the second sensor. In this case, the multiple sensors are redundant, i.e. the information detected and analyzed by one sensor is checked and verified by the information detected and analyzed by another sensor. The data from the two sensors does not have to be processed sequentially but can also be processed in parallel. If the sensors are provided as redundant sensors, a warning signal is preferably only output if both sensors independently detect the presence of a certain characteristic of the other road user. This gives the system increased reliability and redundancy.

Alternatively, the sensors of different types can also be provided as complementary sensors, e.g. one camera is provided for an area to the side of the vehicle and one camera for the area behind the vehicle.

In principle, the first sensor and the second sensor can be sensors of the same type, e.g. both cameras. This is particularly useful if different areas around the vehicle are observed with the different sensors. If the same area of the vehicle's surroundings is observed by the two or more sensors, sensors of different types are preferred.

If several redundant sensors are provided, a malfunction of one sensor can be detected by comparing the analysis results of both or several redundant sensors. If one of the sensors is defective, for example, such a malfunction can lead to two redundant sensors repeatedly producing different analysis results. Such a possible malfunction can then be indicated to the vehicle driver at an early stage so that he can initiate suitable measures, such as repairs, and knows that he can only rely on the system to a limited extent. This ensures that the system is functionally safe according to ISO 26262, for example, which means that the system switches to a safe state in the event of a malfunction, whereby this requires that the driver is made aware that there is a malfunction or that he cannot rely on the system in question.

If several sensors are used to monitor characteristics, it may make sense to trust the sensors differently or to weight them differently and to make the output of the warning signal dependent on whether there is a sufficient probability (depending on the weighting of the sensors) that another road user with a certain characteristic is in the vehicle environment. The weighting can either be fixed or a confidence level of the individual sensors can be calculated when the warning is generated, and the multiple sensors can be weighted accordingly. If no warning is issued based on the results of one sensor, but another sensor clearly perceives a characteristic of another road user, a warning should be issued, e.g. because the sensors are located at different mounting positions on the vehicle. Additionally, or alternatively, it can be helpful to trust different sensors to different degrees in different situations or based on different data. For example, in the case of two optical sensors of different types, it may be known that one of the sensors has a higher quantum efficiency at infrared wavelengths. When detecting halogen blue lights, for example, the infrared component detected by such a sensor can be assigned to a higher reliability and a warning can be issued if the other sensor does not detect an infrared component.

Particularly preferably, the processing unit is adapted to analyze the information regarding the presence of certain patterns in the time course of the characteristics of other road users. For example, the pattern can be a temporally predetermined audio frequency sequence or a temporally predetermined light wavelength sequence. For example, if the sensor is a camera, the pattern corresponding to the certain characteristic may be a particular sequence of detected colors associated with blink pulses and flash pulses. This can additionally or alternatively be linked to certain temporal color gradients (light wavelength gradients). In image analysis, temporal intensity gradients, brightness gradients or similar can also be used in addition to the color itself. In the case of temporal observation and analysis, the temporal course of the characteristic can be analyzed and evaluated in terms of how the position of the light source changes with respect to the vehicle.

The method for warning a vehicle driver includes the following steps:
capturing ambient information with a sensor, wherein the ambient information may comprise information about certain characteristics of other road users;
processing the captured ambient information by means of a processing unit, wherein the processing comprises analyzing the captured ambient information to determine whether the ambient information includes information about other road users;
if the ambient information comprises information about other road users, analyzing the ambient information whether a certain characteristic or certain characteristics of the other road users are present; and outputting a warning signal to the driver of the vehicle by means of an output unit if a certain characteristic or certain characteristics of the other road users are present.

The step of analyzing the ambient information to determine whether this ambient information comprises information about other road users does not have to be carried out as a separate, independent step, but can be carried out together with the step of analyzing with regard to a certain characteristic of the road user if this characteristic is such that it also necessarily allows the conclusion that it is to be assigned to another road user. In this case, the fact that the certain characteristic is detected also means that a road user has the characteristic.

Preferably, the method further comprises the step of verifying the analysis when it is determined that certain characteristics of the other road users are present by capturing ambient information with a second sensor different from the first sensor, analyzing the ambient information captured with the second sensor to determine whether the ambient information comprises information about other road users and whether one or more certain characteristics of the other road users are present.

Preferably, the warning signal is only issued to the driver if the verification step shows that one or more specific characteristics of other road users are present.

According to a preferred embodiment, the warning signal is output when the one or more certain characteristics are present for a certain time, as mentioned above.

### Aspects of the Invention

1. A warning system (100) for warning a driver of a vehicle, comprising
   a sensor (3a, 3b) for capturing ambient information;
   a processing unit (4) for processing information captured by the sensor; and
   an output unit (5, 7, 8, 9) for outputting a warning signal to the vehicle driver (1);
   wherein the sensor (3a, 3b) is adapted to capture information about other road users;
   the processing unit (4) is adapted to analyze the information with respect to the presence of one or more certain characteristics of the other road users, and to output a signal to the output unit (5) for outputting the warning signal when the analysis detects the presence of specific characteristics of other road users.
2. The warning system (100) according to one of the preceding aspects, wherein the warning system (100) is coupled to a mirror replacement system of a vehicle comprising a display for displaying vehicle ambient information to a vehicle driver, wherein the vehicle ambient information comprises mirror replacement information, and the output unit (5) comprises the display.
3. The warning system (100) according to aspect 2, wherein the warning signal comprises a graphic representation on the display.
4. The warning system (100) according to any one of the preceding aspects, wherein the warning signal is output as long as the presence of the certain characteristic or characteristics of other road users is detected.
5. The warning system (100) according to any one of the preceding aspects, wherein the warning signal is only output after a period of time has elapsed during which the presence of the certain characteristic or characteristics is continuously detected.
6. The warning system (100) according to any one of the preceding aspects, wherein the warning signal is an acoustic signal and/or a visual signal.
7. The warning system (100) according to any one of the preceding aspects, wherein the sensor comprises a camera and/or a microphone and/or a radio receiver.
8. The warning system (100) according to any one of the preceding aspects, wherein the sensor is a first sensor (3a), and the warning system comprises a second sensor (3b), which is a sensor different from the first sensor, that outputs information to the processing unit.
9. The warning system (100) according to aspect 8, wherein the first sensor (3a) and the second sensor (3b) are sensors of different type and/or construction.
10. The warning system (100) according to aspect 8 or 9, wherein the processing unit (4) is adapted to analyze the information from the first sensor (3a) and the second sensor (3b) with respect to the presence of certain characteristics of the other road users, and to output a signal to the output unit (5, 7, 8, 9) for outputting the warning signal when the analysis of the information from the first sensor (3a) and/or the analysis of the information from the second sensor (3b) in each case determines the presence of certain characteristics of other road users.
11. The warning system (100) according to any one of the preceding aspects, wherein the processing unit (4) is adapted to analyze the information with respect to the presence of certain patterns in time courses of the characteristic or characteristics of the other road users.
12. The warning system (100) according to aspect 11, wherein the patterns are tone sequences or frequency sequences of a sound signal.
13. The warning system (100) according to aspect 11, wherein the patterns are certain spatial and/or temporal sequences of brightness values and/or wavelengths in visual signals.
14. The warning system (100) according to any one of the preceding aspects, further comprising a driver assistance system (11), wherein the processing unit (4) is adapted to output a signal to the driver assistance system (11) when the analysis detects the presence of certain characteristics of other road users.
15. Method for warning a vehicle driver, comprising the steps of:
   capturing ambient information with a sensor, wherein the ambient information may contain information about certain characteristics of other road users;
   processing the captured ambient information by means of a processing unit, wherein the processing includes analyzing the captured ambient information to determine whether the ambient information includes information about other road users;
   analyzing the ambient information as to whether one or more certain characteristics of the other road users are present; and
   outputting a warning signal to the driver of the vehicle by means of an output unit if the one or more certain characteristics of the other road users are present.
16. The method according to aspect 15, further comprising the step of verifying the analysis when it is determined that one or more certain characteristics of the other road users are present, by
   capturing ambient information with a second sensor that is different from the first sensor,
   analyzing the ambient information captured by the second sensor to determine whether the ambient information contains information about other road users and whether one or more certain characteristics of the other road users are present.
17. The method according to aspect 16, wherein the warning signal is only output to the driver if the verification step results that one or more certain characteristics of other road users are present.
18. The method according to any one of aspects 15 to 17, wherein the warning signal is output when one or more certain characteristics are present for a certain time.
19. The method according to any one of aspects 15 to 18, wherein the warning signal is output until a driver monitoring system determines that the driver has noticed the warning signal.

Other objects and features of the present invention will become apparent from the following detailed description considered in conjunction with the accompanying drawings. It is to be understood, however, that the drawings are designed solely for purposes of illustration and not as a definition of the limits of the invention, for which reference should be made to the appended claims. It should be further understood that the drawings are not necessarily drawn to scale and that, unless otherwise indicated, they are merely intended to conceptually illustrate the structures and procedures described herein.

### BRIEF DESCRIPTION OF THE DRAWINGS

In the following, the invention is described purely by way of example based on the attached figures.

FIG. 1 shows schematically the structure of a warning system according to an embodiment of the invention;

FIG. 2a shows a side view of a vehicle equipped with a warning system according to one embodiment of the invention;

FIG. 2b shows a top view of the vehicle in FIG. 2a;

FIG. 3a shows a vehicle from FIG. 2a, 2b in a driving environment in side view;

FIG. 3b shows a top view of the vehicle from FIG. 3a in the driving environment;

FIG. 4 shows schematically a driver's cab of a vehicle equipped with a warning system according to the invention;

FIG. 5 shows schematically the output of a warning signal according to an embodiment on an output unit;

FIG. 6 shows schematically the output of a warning signal according to a further embodiment on an output unit; and

FIG. 7 shows a flow chart to illustrate the invention.

### DETAILED DESCRIPTION OF THE PRESENTLY PREFERRED EMBODIMENTS

Preferred embodiments are described below with reference to the attached figures.

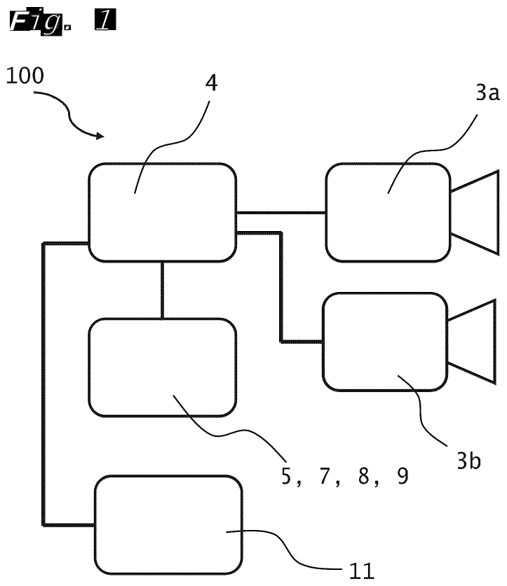

FIG. 1 schematically shows a warning system (100) according to an embodiment of the invention. The warning system (100) comprises a first sensor (3a) and a second sensor (3b) that is independent of the first sensor (3a). Both sensors (3a, 3b) independently capture/acquire ambient information around a vehicle (2).

The sensors (3a, 3b) can each be, for example, a camera, a radio receiver or a microphone. It is preferred that in case of two sensors (3a, 3b) as in the embodiment shown, these sensors are of a different type, i.e. for example one of the sensors (3a) is a camera and the other of the sensors (3b) is a microphone. In principle, any number of sensors, i.e. more than two sensors or even just one sensor, can be provided. For example, different sensors can be directed to different areas of the vehicle's surroundings. The arrangement of the sensors on the vehicle is arbitrary, in particular whether they are arranged at one or more locations on the vehicle.

The sensors (3a, 3b) are coupled to a processing unit (4), to which the sensors (3a, 3b) forward the captured information for further processing, in particular analyzing.

The processing unit (4) is adapted to analyze the ambient information received from the sensors (3a, 3b) to determine whether there are road users with one or more certain characteristics in the captured vehicle environment.

To enable the warning system (100) to output a warning signal to a vehicle driver (1), the warning system (100) also comprises one or more output units (5, 7, 8, 9). The output units (5, 7, 8, 9) can be, for example, displays, loudspeakers, a head-up display, a vehicle multi-media system or the like.

Furthermore, in the shown embodiment, the processing unit (4) is coupled to a driver assistance system (11) and can also output signals thereto, so that the driver assistance system (11) can take or suggest suitable measures, such as slowing down driving, for example.

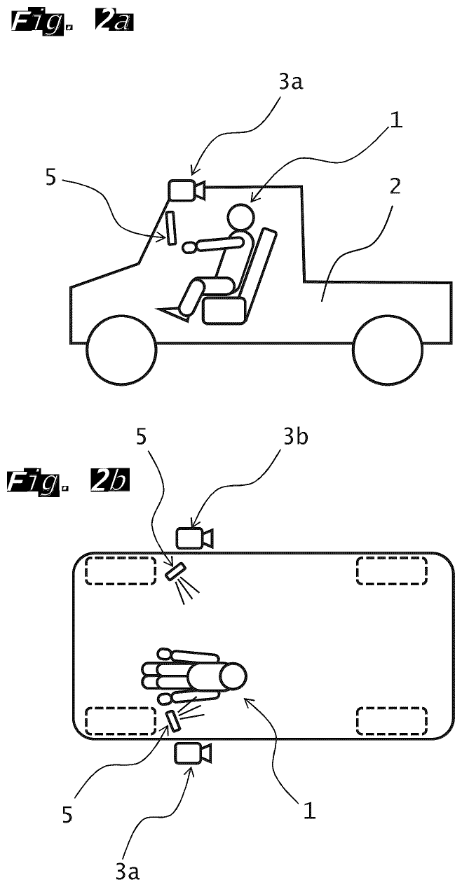

FIGS. 2a and 2b show a side view, respectively a top view of a vehicle (2) equipped with a warning system (100) according to a further embodiment. In this case, a first sensor (3a) is provided on both sides of the vehicle, e.g. as a camera in each case, whereby different areas around the vehicle can be detected with each of the sensors (3a), which can each be analyzed regarding the presence of the same characteristics, e.g. light wavelengths.

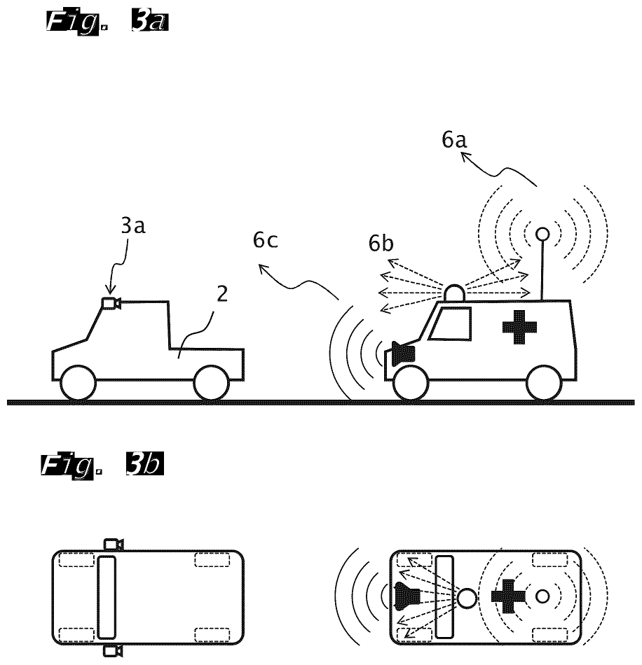

FIGS. 3a and 3b show an exemplary side view of a vehicle (2) corresponding to the vehicle shown in FIGS. 2a and 2b, in the rear area of which there is an emergency vehicle, e.g. a rescue vehicle, which, when it is in action, emits certain signals which can be captured by a sensor (3a) attached to the vehicle (2). FIGS. 3a and 3b show that the rescue vehicle emits acoustic ambient information (6c), optical ambient information (6b) and radio waves (6a) as ambient information. It is of course possible for the rescue vehicle to emit all different types of ambient information simultaneously, or only some of them, e.g. only blue light (optical ambient information (6b)) and siren signals (acoustic ambient information (6c)).

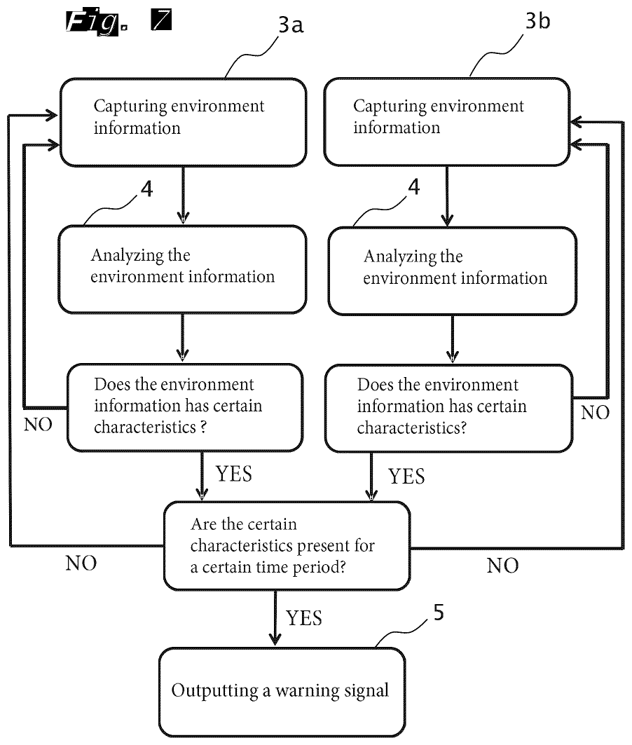

FIG. 7 schematically shows a flow diagram of the embodiment shown in FIG. 1 to illustrate how the warning system (100) operates, i.e. how the method for warning a vehicle driver is performed according to an embodiment. The steps shown in FIG. 7 are continuously repeated.

When ambient information is captured by the sensors (3a, 3b), the information is analyzed in the processing unit (4), respectively. In this process, it is determined whether the ambient information comprises information indicating that another road user is in the vicinity of the vehicle. If this is the case, or at the same time as or in conjunction with this analysis, the information is analyzed to determine whether the ambient information comprises one or more certain characteristics that indicate, for example, an emergency vehicle or rescue vehicle in use/action. If the ambient information is captured by means of an optical sensor (3a, 3b), there can, for example, be an analysis of whether the road user has switched on a warning light (blue light). This can be done, for example, by image analysis with respect to colors or temporally sequential color patterns, by analyzing the detected light wavelengths and/or their patterns. If the ambient information is detected (acoustically), for example by means of a microphone and is available as acoustic information, a frequency analysis can determine tones or tone sequences that indicate an emergency vehicle siren (martins-horn).

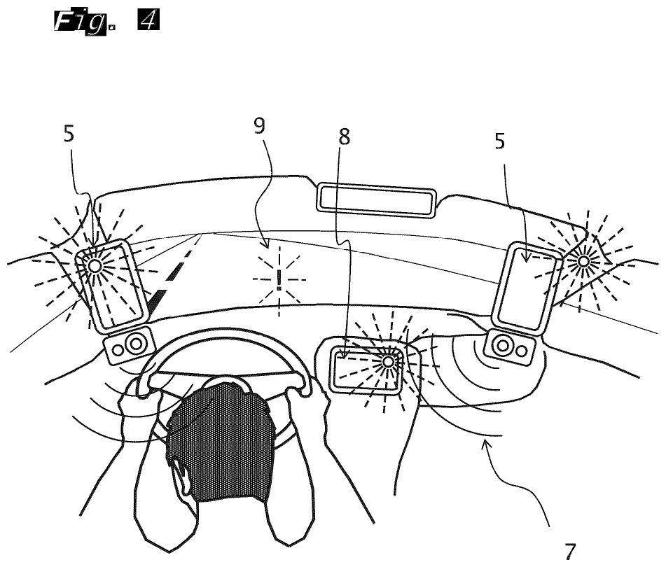

If the processing unit (4) determines that one or more specific characteristics are present, it outputs a signal to a output unit (described in connection with FIGS. 4 to 6) so that the latter outputs a warning signal to a vehicle driver.

In the embodiment shown in FIG. 7, the signal is not output immediately as soon as it first occurs, but only after it has been present for a certain time. The procedure and the steps described are repeated for this time. Only when the one certain characteristic or the several certain characteristics are present for a certain period of time, the signal is output to the vehicle driver in order to prevent the output of unneeded warning signals to the vehicle driver, such as an emergency vehicle crossing at the rear of the vehicle.

In the embodiment shown in FIG. 7, the ambient information is also captured redundantly by two different sensors (3a, 3b) and analyzed independently by the processing unit (4). The warning signal is only output when the ambient information from both sensors (3a, 3b) indicates the presence of certain characteristics of the other road user. This also ensures that there are no unnecessary warnings to the vehicle driver.

FIGS. 4 to 6 schematically show various embodiments for an output unit and for warning signals.

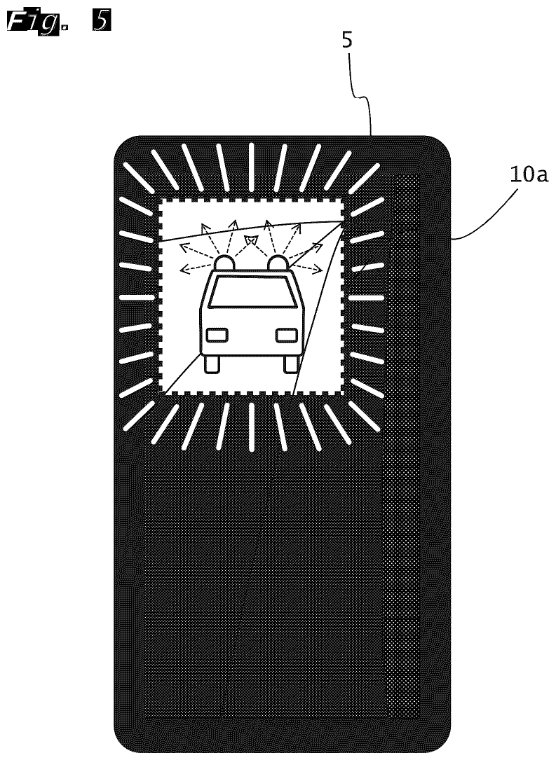

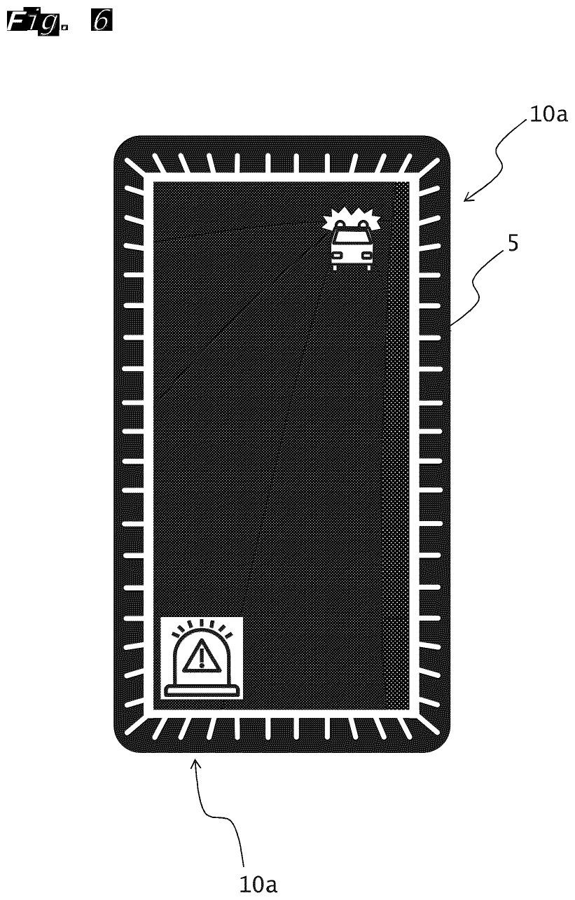

FIG. 4 shows a driver's cab with a left and a right display (5), on each of which, for example, mirror replacement information is shown. If a warning signal is to be issued, this can be done, for example, by showing a corresponding overlay (10a) as a visual warning signal on the display (5) (FIG. 5), or by, for example, the frame of the display (5) flashing or otherwise being highlighted and/or a symbol being shown as a visual signal (10a) (FIG. 6).

Alternatively, or additionally, as indicated in FIG. 4, an acoustic warning can be given by means of a multi-media device (8) of the vehicle, for example by outputting a special sound, e.g. a beep, or by turning down the volume of the sound output of the multi-media device (8). A separate, dedicated loudspeaker (7) as an output unit for warning tones, e.g. warning tones of all kinds, is also possible.

A further option shown in FIG. 4 is to show visual warning information in a head-up display (9).

With the described warning system (100) and the method for warning a vehicle driver, a vehicle driver can be reliably informed at an early stage and in good time if an emergency vehicle is in the vicinity of his vehicle, even if there is a strong focus on road traffic, for example.

It is explicitly emphasized that all features disclosed in the description and/or claims are to be considered separate and independent from each other for the purpose of the original disclosure as well as for the purpose of limiting the claimed invention, irrespective of the combinations of features in the embodiments and/or claims. It is explicitly stated that all range indications or indications of groups of units disclose any possible intermediate value or subgroup of units for the purpose of the original disclosure as well as for the purpose of limiting the claimed invention, in particular also as the limit of a range indication.

Thus, while there have shown and described and pointed out fundamental novel features of the invention as applied to a preferred embodiment thereof, it will be understood that various omissions and substitutions and changes in the form and details of the devices illustrated, and in their operation, may be made by those skilled in the art without departing from the spirit of the invention. For example, it is expressly intended that all combinations of those elements and/or method steps which perform substantially the same function in substantially the same way to achieve the same results are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

What is claimed is:

1. A warning system for warning a driver of a vehicle, comprising
a sensor for capturing ambient information;
a processing unit for processing information captured by the sensor; and
an output unit for outputting a warning signal to the vehicle driver;
wherein the sensor is adapted to capture information about other road users;
the processing unit is adapted to analyze the information with respect to the presence of one or more certain characteristics of the other road users, and to output a signal to the output unit for outputting the warning signal when the analysis detects the presence of specific characteristics of other road users.

2. The warning system according to claim 1, wherein the warning system is coupled to a mirror replacement system of a vehicle comprising a display for displaying vehicle environment information to a vehicle driver, wherein the vehicle environment information comprises mirror replacement information, and the output unit comprises the display.

3. The warning system according to claim 2, wherein the warning signal comprises a graphic representation on the display.

4. The warning system according to claim 1, wherein the warning signal is output as long as the presence of the certain characteristic or characteristics of other road users is detected.

5. The warning system according to claim 1, wherein the warning signal is only output after a period of time has elapsed during which the presence of the certain characteristic or characteristics is continuously detected.

6. The warning system according to claim 1, wherein the warning signal is an acoustic signal and/or a visual signal.

7. The warning system according to claim 1, wherein the sensor comprises a camera and/or a microphone and/or a radio receiver.

8. The warning system according to claim 1, wherein the sensor is a first sensor, and the warning system comprises a second sensor, which is a sensor different from the first sensor that outputs information to the processing unit.

9. The warning system according to claim 8, wherein the first sensor and the second sensor are sensors of different types and/or construction.

10. The warning system according to claim 8, wherein the processing unit is adapted to analyze the information from the first sensor and the second sensor with respect to the presence of certain characteristics of the other road users, and to output a signal to the output unit for outputting the warning signal when the analysis of the information from the first sensor and/or the analysis of the information from the second sensor in each case determines the presence of certain characteristics of other road users.

11. The warning system according to claim 1, wherein the processing unit is adapted to analyze the information with respect to the presence of certain patterns in time courses of the characteristic or characteristics of the other road users.

12. The warning system according to claim 11, wherein the patterns are tone sequences or frequency sequences of a sound signal.

13. The warning system according to claim 11, wherein the patterns are certain spatial and/or temporal sequences of brightness values and/or wavelengths in visual signals.

14. The warning system according to claim 1, further comprising a driver assistance system, wherein the processing unit is adapted to output a signal to the driver assistance system when the analysis detects the presence of certain characteristics of other road users.

15. A method for warning a vehicle driver, comprising the steps of:
capturing ambient information with a sensor, wherein the ambient information may contain information about certain characteristics of other road users;
processing the captured ambient information by means of a processing unit, wherein the processing includes analyzing the captured ambient information to determine whether the ambient information includes information about other road users;
analyzing the ambient information as to whether one or more certain characteristics of the other road users are present; and
outputting a warning signal to the driver of the vehicle by means of an output unit if the one or more certain characteristics of the other road users are present.

16. The method according to claim 15, further comprising the step of verifying the analysis when it is determined that one or more certain characteristics of the other road users are present, by
capturing ambient information with a second sensor that is different from the first sensor,
analyzing the ambient information captured by the second sensor to determine whether the ambient information contains information about other road users and whether one or more certain characteristics of the other road users are present.

17. The method according to claim 16, wherein the warning signal is only output to the driver if the verification step results that one or more certain characteristics of other road users are present.

18. The method according to claim 15, wherein the warning signal is output when one or more certain characteristics are present during a certain time period.

19. The method according to claim 15, wherein the warning signal is output until a driver monitoring system determines that the driver has noticed the warning signal.
